(19) United States
(12) Patent Application Publication
(10) Pub. No.: US 2011/0131096 A1
(43) Pub. Date: Jun. 2, 2011

(54) TARGETED ENROLLMENT

(75) Inventors: David T. Frew, Fort Mill, SC (US); Zhongmin Agarwal, Charlotte, NC (US); Kevin Kenny, Matthews, NC (US); Sylvan Tran, Corona, CA (US); Clarence E. Lee, II, Mansfield, TX (US); James A. Robinson, Charlotte, NC (US); Rodney Ermish, Conifer, CO (US)

(73) Assignee: BANK OF AMERICA CORPORATION, Charlotte, NC (US)

(21) Appl. No.: 12/955,593

(22) Filed: Nov. 29, 2010

Related U.S. Application Data
(60) Provisional application No. 61/265,670, filed on Dec. 1, 2009.

(51) Int. Cl. G06Q 30/00

(52) U.S. Cl. 705/14.66

(57) ABSTRACT

Embodiments of the invention relate to apparatuses and methods for providing targeted product offers to customers. For example, in one embodiment, a first entity sends a targeted offer to certain customers. The first entity uses a second entity to perform a service related to the offer, such as an enrollment service. The first entity sends a candidate file to the second entity, where the candidate file includes a list of customers that qualify for the offer. The first entity authenticates the customer and, when the customer expresses interest in the targeted offer, the first entity forwards the customer to the second entity along with customer identifying information so that the second entity can perform the related service. The second entity then verifies whether the transferred customer qualifies for the offer by comparing the customer information to the candidate file. If verified, the second entity can perform the service related to the offer for the customer.

### CROSS REFERENCE TO RELATED APPLICATIONS

This application claims benefit of priority under 35 U.S.C. §119(e) to the filing date of U.S. Provisional Application No. 61/265,670, entitled “Secure Automated Enrollment,” as filed on Dec. 1, 2009, which is incorporated herein by reference in its entirety.

### FIELD

Embodiments of the invention relate generally to the field of providing targeted online offers.

### BACKGROUND

Companies often desire to attract customers by providing certain customers with targeted offers. For example, some targeted offers include an offer for a new program in which the particular customer is qualified to enroll. Many conventional enrollment processes involve a customer talking to a customer service representative. Such conventional enrollment processes can be expensive, time consuming, unable to handle targeted customer-specific offers, and unable to handle significant volume. Additionally, when offering targeted customer-specific offers, there are problems with customers sharing the offer with people for whom the offer was not intended.

Companies also often hire other companies to perform certain online functions on behalf of the company. For example, a first company may hire a second company to enroll its customers in a new program. This type of arrangement is difficult to manage where the program being offered is targeted to less than all of the first company's customers. Furthermore, where customer information is used during the enrollment process, there can also sometimes be security concerns associated with the first company sharing customer information with the second company.

Therefore, what is needed is an automated system for managing customer acceptance of targeted offers and/or enrollment into targeted programs. It would further be beneficial if some such systems allowed an entity different from the entity providing the offer to manage offer-related services, such as offer acceptance and enrollment services.

### BRIEF SUMMARY

Embodiments of the invention relate to apparatuses and methods for providing targeted product offers to customers and managing customer acceptance of or enrollment in the offered products. For example, in one embodiment, a first entity sends a targeted offer to some of its customers. The first entity uses a second entity to perform a service related to the offer, such as an enrollment service. The first entity sends a candidate file to the second entity. The candidate file includes a list of customers that qualify for the offer. The first entity authenticates the customer and, when the customer expresses interest in the targeted offer, the first entity forwards the customer to the second entity along with customer identifying information so that the second entity can perform the related service. The second entity then verifies whether the transferred customer qualifies for the offer by comparing the customer information to the candidate file. If verified, the second entity can perform the service related to the offer for the customer.

For example, in one embodiment of the invention, the first entity is a financial institution providing an offer for a mobile deposits program to some, but not all, of its customers, and the second entity is an enrollment service provider that the financial institution uses to securely enroll customers into the mobile deposits program. In such an embodiment, the financial institution may, for example, email the offer to qualifying customers, where the email includes a web link that a recipient of the email can use to attempt to accept the offer. When the email recipient uses the link, the recipient is connected to a financial institution server and, at some point, asked to authenticate his or her identity by, for example, logging into an online banking account. Once authenticated, the financial institution knows the identity of the email recipient and then can forward the email recipient to the enrollment service provider's server along with a code uniquely identifying the authenticated email recipient. The enrollment service provider then compares the code to a candidate list associated with the mobile deposits offer. The candidate list is earlier provided to the enrollment service provider from the financial institution and includes the codes for all of the financial institution's customers that qualify for the mobile deposits offer. If the code for the email recipient is in the candidate file, then the enrollment service provider enrolls the email recipient in the mobile deposits program. However, if the code for the email recipient is not in the candidate file, then the enrollment service provider does not enroll the email recipient in the mobile deposits program. This prevents a situation where a qualifying customer receives an offer from the financial institution, the qualifying customer then forwards the offer to a customer that does not qualify for the offer, and then the non-qualifying customer accepts the offer. It will be understood that the foregoing is just one example of how one embodiment of the invention may work. Other embodiments of the invention are discussed below.

Other embodiments than those explicitly disclosed above are within the scope of the present invention and the above embodiments are not meant to limit the present invention.

### BRIEF DESCRIPTION OF THE SEVERAL VIEWS OF THE DRAWINGS

Having thus described embodiments of the invention in general terms, reference will now be made to the accompanying drawings, wherein:

FIG. 1 provides a block diagram illustrating an offer and enrollment system, in accordance with an embodiment of the invention;

FIG. 2 provides a block diagram illustrating a personal computing device of an offer and enrollment system, in accordance with an embodiment of the invention;

FIG. 3 provides a block diagram illustrating an online system involving authentication, in accordance with an embodiment of the invention;

FIG. 4 provides a block diagram illustrating an enrollment system, in accordance with an embodiment of the invention;

FIG. 5 provides a block diagram illustrating an application download server, in accordance with an embodiment of the invention;

FIGS. 6A, 6B, 7, and 8 provide flow charts illustrating a process for offering a product to a customer and enrolling the customer with such product, in accordance with some embodiments of the invention; and

FIGS. 9-20 provide graphical user interfaces illustrating exemplary processes to offer and enroll a customer in a product on a personal computing device (e.g., computer, mobile phone, etc.), in accordance with some embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, and/or operational aspects of any of the embodiments described and/or contemplated herein may be included in any other embodiment of the present invention described and/or contemplated herein, and vice versa. In addition, where possible, any terms expressed in the singular form herein are meant to also include the plural form and/or vice versa, unless explicitly stated otherwise. Accordingly, the terms “a” and “an” shall mean “one or more,” even though the phrase “one or more” is also used herein. Like numbers refer to like elements throughout.

It should be understood that terms like “bank” and “financial institution” are used herein in their broadest sense. The term “financial institution” is intended to encompass all such possibilities, including but not limited to, banks, finance companies, stock brokerages, credit unions, mortgage companies, organizations that issue bills to consumers, organizations that pay bills on behalf of consumers, etc. Additionally, disclosed embodiments may suggest or illustrate the use of agencies or contractors external to the financial institution to perform some or all of the processes and data repository services. These illustrations are examples only and an institution or business can implement the entire invention on its own computer systems or even a single work station if appropriate databases are present and can be accessed.

It should be understood that the term “first entity,” as used herein, refers to a financial institution or any other entity that has customers. The term “second entity,” as used herein, refers to a company or institution that is separate from the first entity, in accordance with one embodiment. In another embodiment “second entity” is a division of or a part of the first entity.

It should also be noted that the terms “customer” and “user,” as used herein, are deemed to be interchangeable and thus, refer to the same entity. In one embodiment, the term “customer” refers to an existing customer of the first entity (e.g., a financial institution or other company). In other embodiments, the term “customer” does not necessarily refer to an existing customer of the first entity, but can also refer to potential customers or persons who are not current existing customers of the first entity.

As used herein, the term “products” refers to goods and/or services. For example, in one embodiment of the invention, the product being offered by the first entity is a mobile deposit service that a customer can use to deposit checks into the customer's account using a mobile phone. In some such embodiments of the invention, a second entity is used to enroll the first entity's customers in the mobile deposit service.

As a high-level overview of some embodiments of the invention, a bi-furcated process of offering products to a targeted list of customers of a first entity will now be described. A first entity (e.g., a financial institution or company) determines which of their customers qualify for a special offer (e.g., a “targeted” or “customer-specific” offer that may be offered to less than all of the fist entity's customers) for a product. An offer-specific list of pre-qualified customers is sent from the first entity to the second entity (e.g., a third-party provider of enrollment services) via a candidate file. The qualified customers are then notified of the special offer and, if these pre-qualified customers are interested in the offer, they log into the online system of the first entity. After the customer logs into the online system of the first entity, an identification of the logged-in customer in is sent to the second entity and the second entity then compares the candidate file with this customer identification to verify that the customer is qualified to receive the special offer. Then, if the logged-in customer is verified, the special offer is provided to the customer by the second entity and the second entity enrolls the customer upon customer acceptance. This process greatly reduces fraud and allows the first entity to provide and manage targeted customer-specific offers. For example, a bank may create a mobile deposit program that is only suitable for certain customer's having a risk rating below a certain threshold. A customer that qualifies for this program would receive a notice of the offer to enroll in the program. Embodiments of the invention would prevent an unqualified customer from successfully enrolling in the program even if a qualified customer forwards the offer notice to the unqualified customer.

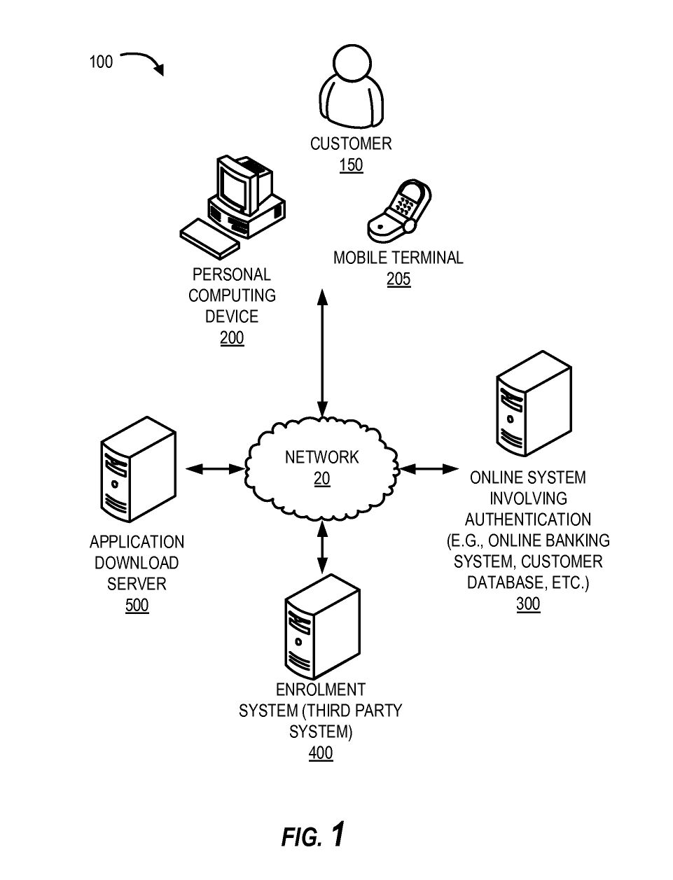

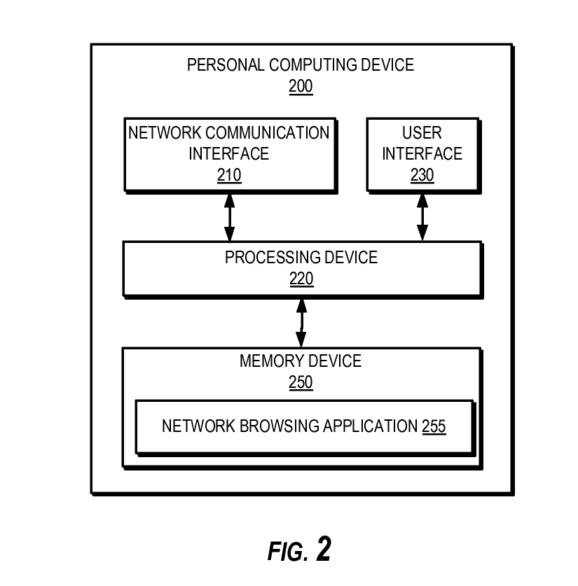

In this regard, FIG. 1 illustrates an offer and enrollment system 100 in accordance with an embodiment of the invention. As illustrated in FIG. 1, the offer and enrollment system 100 includes a personal computing device 200. The personal computing device 200 is any device which employs a processor and memory and can perform computing functions, such as a personal computer or a mobile terminal 205. The mobile terminal 205 is any mobile electronics device, such as a cellular telecommunications device (i.e., a cell phone or mobile phone), a laptop, personal digital assistant (PDA), a mobile Internet accessing device, or other mobile device. The personal computing device 200 and mobile terminal 205 are configured to communicate over a network 20 with an application download server 500, an online system involving authentication 300, and/or an enrollment system 400. The personal computing device 200, application download server 500, online system involving authentication 300, and enrollment system 400 are each described in greater detail below with reference to FIGS. 2-5. The network 20 may include a local area network (LAN), a wide area network (WAN), and/or a global area network (GAN). The network 20 may provide for wireline, wireless, or a combination of wireline and wireless communication between devices in the network. In one embodiment, the network 20 includes the Internet.

In general, a personal computing device 200 is configured to connect with the online system 300 to log the customer 150 into the system 300. The online system 300 involves authentication of a customer in order to access the customer's account on the online system 300. For example, the online system 300 is a system where a customer 150 logs into his/her account such that the customer 150 or other entity can access data that is associated with the customer 150. For example, in one embodiment of the invention, the online system 300 is an online banking system maintained by a financial institution. In such an embodiment, the customer 150 can use the personal computing device 200 to log into the online banking system to access the customer's online banking account. Logging into the online system 300 generally requires that the customer 150 authenticate his/her identity using a user name, passcodes, cookies, biometrics, private keys, tokens, and/or other authentication devices that are provided by the customer 150 to the online system 300 via the personal computing device 200.

The online system 300 communicates certain data with other devices connected to the network 20, such as the personal computing device 200 and the application download server 500. In one embodiment, the online system 300 provides an offer for a new product to the customer 150 and, if the customer 150 chooses to accept the offer, the online system 300 forwards the customer 150 to the enrollment system 400 that enrolls the customer 150 in the new product. In some cases, enrollment in the new product requires that the customer 150 download a software application from the application download server 500 to the personal computing device 200.

In some embodiments of the invention, the application download server 500 and the enrollment system 400 are configured to be controlled and managed by one or more third-party data providers (not shown) over the network 20. In other embodiments, the application download server 500 and the enrollment system 400 are configured to be controlled and managed over the network 20 by the same entity that maintains the online system 300.

Referring now to FIG. 2, the personal computing device 200 includes various features, such as a network communication interface 210, a processing device 220, a user interface 230, and a memory device 250. The network communication interface 210 includes a device that allows the personal computing device 200 to communicate over the network 20.

As used herein, a “processing device,” such as the processing device 220, generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” generally includes interface devices and/or software that allow a customer to input commands and data to direct the processing device to execute instructions. For example, the user interface 230 presented in FIG. 2 may include a graphical user interface (GUI) or an interface to input computer-executable instructions that direct the processing device 220 to carry out specific functions. The user interface 230 employs certain input and output devices to input data from the customer 150 or output data to the customer 150. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” generally refers to a device or combination of devices including one or more forms of computer-readable media for storing data and/or computer-executable program code/instructions. Computer-readable media is defined in greater detail below. For example, in one embodiment, the memory device 250 includes any computer memory that provides an actual or virtual space to temporarily store data and/or commands provided to the processing device 220 when it carries out its functions described herein.

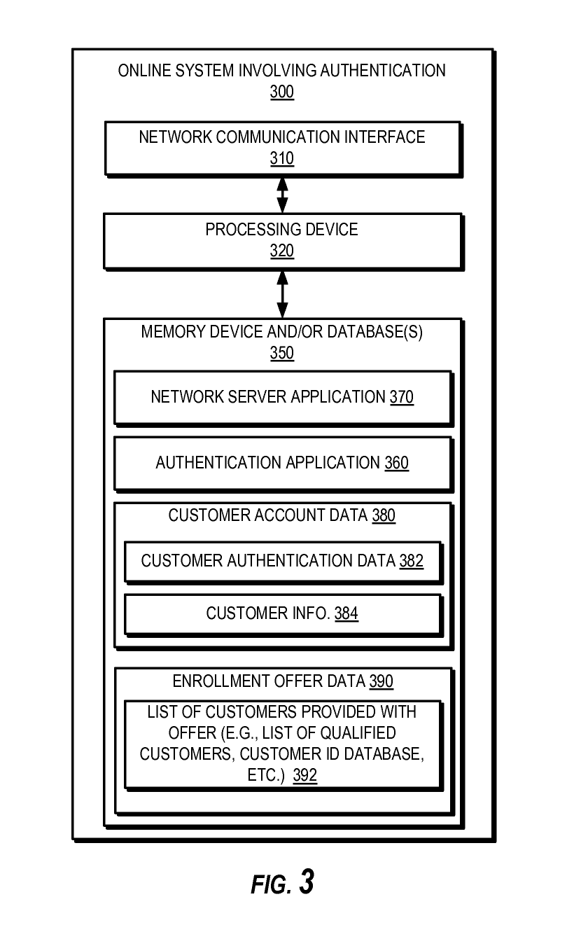

FIG. 3 provides a block diagram illustrating the online system involving authentication 300 in greater detail, in accordance with an embodiment of the invention. As illustrated in FIG. 3, in one embodiment of the invention, the online system 300 includes a processing device 320 operatively coupled to a network communication interface 310 and a memory device 350. In one embodiment, the online system 300 is owned, managed and operated by a first entity, such as a financial institution.

It should be understood that the memory device 350 may include one or more databases or other data structures/repositories. The memory device 350 also includes computer-executable program code that instructs the processing device 320 to operate the network communication interface 310 to perform certain communication functions of the online system 300 described herein. For example, in one embodiment of the online system 300, the memory device 350 includes a network server application 370, an authentication application 360, customer account data 380, enrollment offer data 390, and other computer-executable instructions or other data. The computer-executable program code of the network server application 370 and the authentication application 360 may instruct the processing device 320 to perform certain logic, data-processing, and data-storing functions of the online system 300 described herein, as well as communication functions of the online system 300.

The customer account data 380 includes customer authentication data 382 and customer contact information 384. The enrollment offer data 390 includes a list 392 of customers qualified for each special offer. The network server application 370 and the authentication application 360 are configured to extract and use the customer account data 380 and/or the enrollment offer data 390 when authenticating the customer 150 to the online system 300 and also when enrolling the customer in the special offer presented to the customer. The enrollment offer data 390 and customer account data 380 are discussed in more detail below.

As used herein, a “communication interface” generally includes a modem, server, transceiver, and/or other device for communicating with other devices on a network, and/or a user interface for communicating with one or more customers. Referring again to FIG. 3, the network communication interface 310 is a communication interface having one or more communication devices configured to communicate with one or more other devices on the network 20, such as the personal computing device 200 and the enrollment system 400. The processing device 320 is configured to use the network communication interface 310 to transmit and/or receive data and/or commands to and/or from the other devices connected to the network 20.

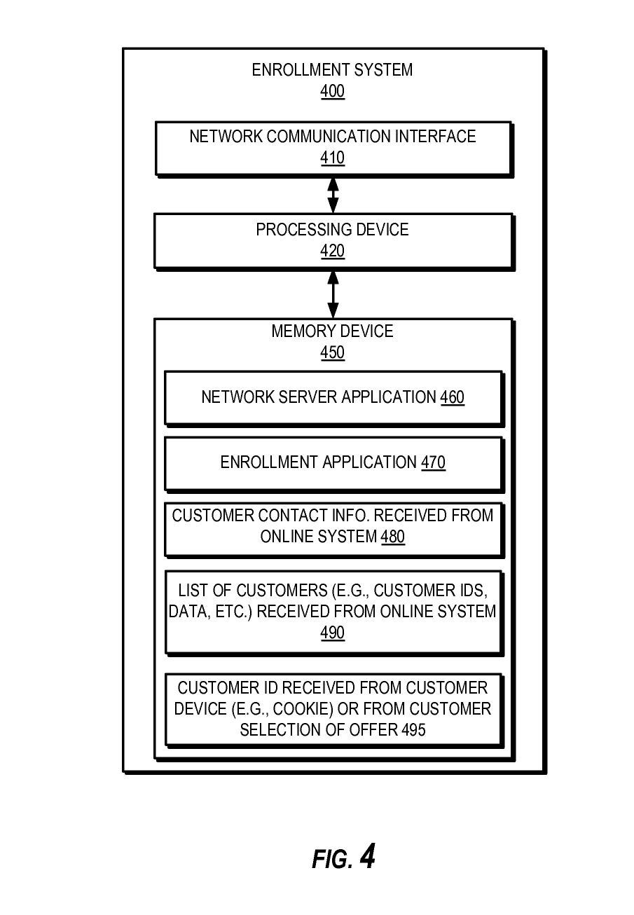

FIG. 4 provides a block diagram illustrating an enrollment system 400, in accordance with an embodiment of the invention. In one embodiment of the invention, the enrollment system 400 is owned, managed and operated by a second entity (referred herein as a “second entity”) that is a different or separate entity from the first entity (e.g., the financial institution) that manages the online system 300. As illustrated in FIG. 4, the enrollment system 400 generally includes a network communication interface 410, a processing device 420, and a memory device 450. The processing device 420 is operatively coupled to the network communication interface 410 and the memory device 450. In one embodiment of the enrollment system 400, the memory device 450 includes a network server application 460 and an enrollment application 470, both having computer-executable program code that instructs the processing device 420 to operate the network communication interface 410 to perform certain communication functions of the enrollment system 400 described herein. The computer-executable program code of the network server application 460 and an enrollment application 470 may also instruct the processing device 420 to perform certain logic, data processing, and data storing functions of the enrollment system 400 described herein.

The network communication interface 410 is a communication interface having one or more communication devices configured to communicate with one or more other devices on the network 20. The processing device 420 is configured to use the network communication interface 410 to receive information from and/or provide information and commands to a personal computing device 200, the application download server 500, the enrollment application 470, the online system 300 and/or other devices via the network 20. In some embodiments, the processing device 420 also uses the network communication interface 410 to access other devices on the network 20, such as one or more web servers of one or more third-party data providers. In some embodiments, one or more of the devices described herein may be controlled and managed by a second entity so that the third-party controls the enrolling the customer into the new product/service that is offered to the customer. For example, in one embodiment of the invention, although the online system 300 is owned and managed by a first entity (e.g., a financial institution), a second entity owns and operates the enrollment system 400 that enrolls the customer into the special offer presented through the online system 300.

As described above, the processing device 420 is configured to use the network communication interface 410 to gather data from the various data sources. The processing device 420 stores the data that it receives in the memory device 450. In this regard, in one embodiment of the invention, the memory device 450 includes datastores that include, for example: (1) customer contact information 480 received from the online system 300; (2) an offer-specific list 490 of customer IDs received from the online system 300; and/or (3) customer credentials 495 (e.g., a customer ID) received from the customer's personal computing device 200 or from the online system 300 in response to the customer's selection of the special offer.

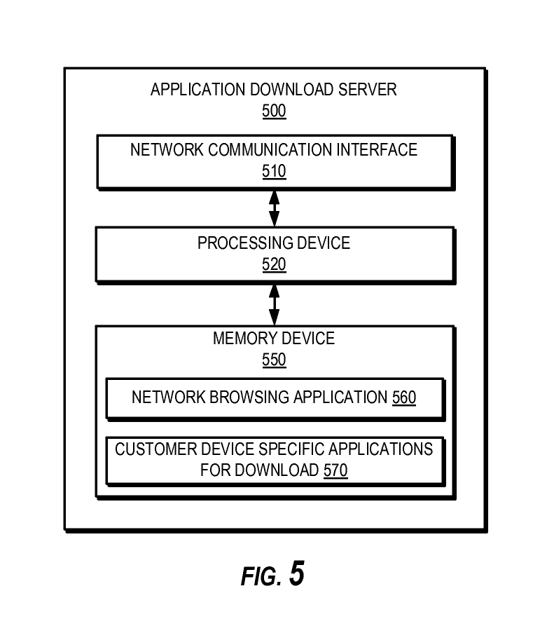

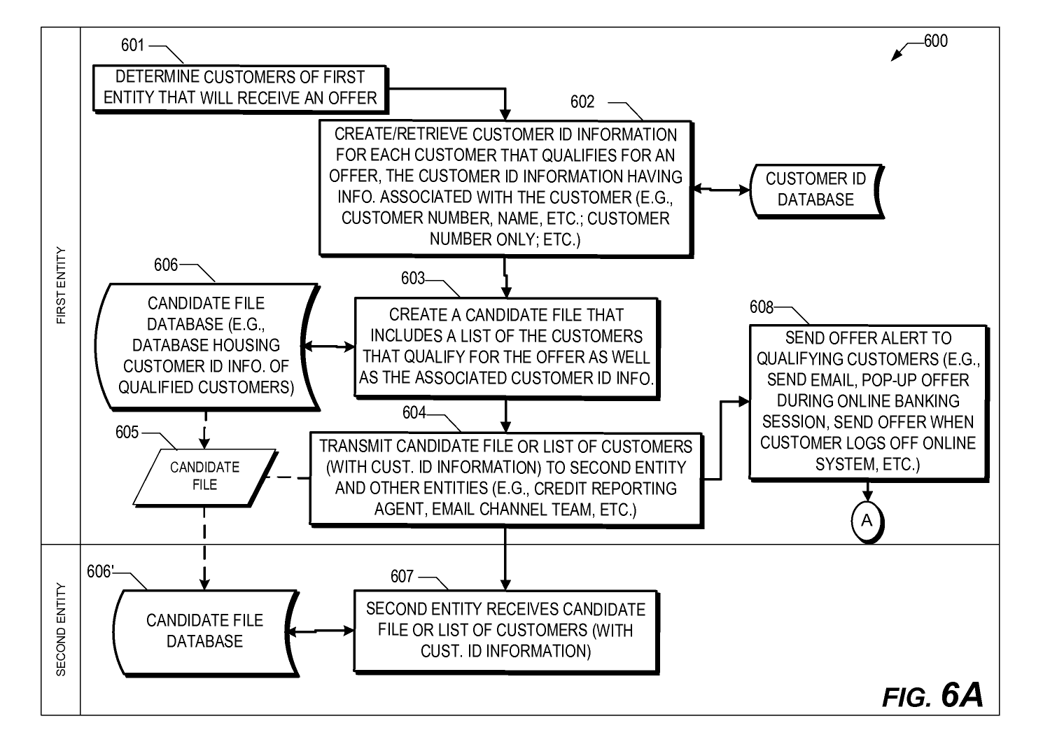

FIG. 5 provides a block diagram illustrating an application download server 500, in accordance with an embodiment of the invention. As illustrated in FIG. 5, the application download server 500 includes a network communication interface 510, a processing device 520, and a memory device 550. The network communication interface 510 and processing device 520 are similar to the previously described network communication interface 410 and the processing device 420 previously described. For example, the processing device 520 is operatively coupled to the network communication interface 510 and the memory device 550. In one embodiment of the application download server 500, the memory device 550 includes a network browsing application 560 having computer-executable program code that instructs the processing device 520 to operate the network communication interface 510 to perform certain communication functions of the application download server 500 described herein.

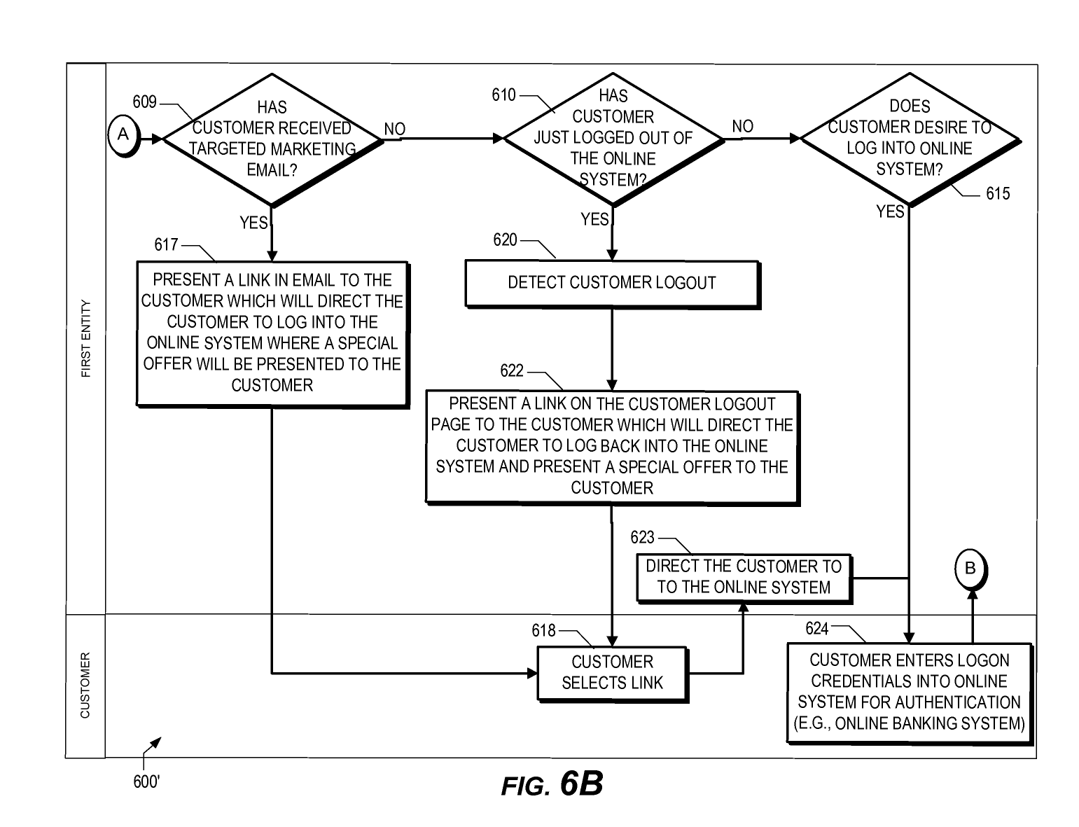

As discussed in greater detail below, in some embodiments of the invention, the application download server 500 provides applications related to a special offer that are to be downloaded to a qualified customer's personal computing device 200. In this regard, the network browsing application 560 receives a request for a device-specific application to be downloaded to a customer's personal computing device 200. For example, a customer 150 may desire to download a mobile deposit application to her personal computing device 200. This process is discussed further below with reference to FIGS. 6-24.

FIGS. 6-8 provide flow charts illustrating a process 600 for offering a product to a customer 150 and enrolling the customer 150 in such product, in accordance with an embodiment of the invention. FIGS. 6-8 illustrate the flow chart in terms of “swim lanes” associated with entities which may perform the operations in each respective swim lane. The entities illustrated in the exemplary Figures are the first entity, second entity, and customer. However, it should be noted that other entities could also be involved and some embodiments of the invention may not be limited to the three entities illustrated in FIGS. 6-8. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity (or even in the customer swim lane).

In the illustrated embodiment of the invention, the process 600 begins by an event or happening that triggers a special offer to be presented to a customer of a first entity, such as a financial institution or other company. In block 601, a determination as to which customers of the first entity will receive special offers is received. In one embodiment, the special offer is an offer for a product of the financial institution or other company to at least one customer thereof. For example, the special offer may be an invitation to participate in a new program offered by the first entity. In some embodiments, the special offer is presented to only a pre-selected group of customers based on various factors, such as reliability of the customer, customer relationship-based criteria, product-based criteria, the customer's loyalty, the customer's risk rating, or any other criteria. For example, where the first entity is providing offers for customers to enroll into a mobile deposits program that allows enrolled customers to deposit checks into their accounts using only their mobile phone to capture and upload the check to the financial institution, the first entity may want to only allow customers with a high credit score or low risk rating to enroll in the program to limit the risk of fraud involving the mobile deposits program.

As shown by block 602, the preselected group of customers is selected by the first entity and customer identification (“ID”) information is created or retrieved for each qualified customer. The customer ID information includes information associated with the customer, such as customer name, customer ID, customer account identifier, and/or any other information that identifies the customer or customer account. For example, in one embodiment of the invention, each customer ID is a number or a series of characters (e.g., one customer ID could be 34994655806) that is associated with a customer account at the first entity. Additionally, each customer ID may be configured to conceal the identity of the customer and/or personal information about the customer, such as the customer's name, bank account number, financial information, contact information, and/or any other information owned by the first entity that the first entity does not want to send to the second entity. For example, instead of sending “John Smith, Bank Account Number 00009954114” to the second entity performing the enrollment service, the financial institution may send a customer ID (e.g., #34994655806) which is associated with John Smith's bank account. In other embodiments, the customer ID information is simply the customer's name, an ID associated with the customer, the customer's account number, or some other identification associated with the customer. For example, in one embodiment of the invention, the customer ID information includes only a customer ID that is associated with the customer but conceals the customer's identity.

The preselected group of customers for each special offer is stored in a data repository, such as a database, at the first entity. The list of customers qualifying for a particular offer is provided to the second entity by the first entity, such as via a “candidate file.” As represented by block 603, such a candidate file 605 is created and stored in a candidate file data repository 606. The candidate file 605 could be a text file, spreadsheet (e.g., Microsoft® Excel), or database-based file (e.g., Microsoft® Access, SAS®, SQL file, etc.) that includes a list of customers that qualify for the offer as well as any associated customer ID information. In one embodiment of the invention, the candidate file 605 includes only customer IDs associated with the customers but conceals the customers' identity. In another embodiment, the candidate file 605 includes customer ID, customer account, customer account information, customer name, and other customer ID information. Each qualified customer has a separate entry in the candidate file. In one embodiment, the candidate file is stored in the memory device of the online system 300 in the form of list 392.

The candidate file 605, which includes the list of targeted customers who qualify under predetermined selection criteria for a particular offer, is provided to the second entity. As described above, the second entity may be one that has contracted with the first entity to provide services related to one or more special offers, such as enrollment services for enrolling a select group of the first entity's customers in a new program offered by the first entity. The candidate file passes a list of “customer IDs” or other customer information to the second entity so that the second entity can later verify that the customer is qualified for the special offer. For example, as represented by block 604, the candidate file 605 is transmitted from the online system 300 of the first entity to the enrollment system 400 of the second entity.

As represented by block 607, the second entity receives the candidate file 606 from the first entity and stores the candidate file in a candidate file database 606′ at the second entity, such as in the form of list 490 stored in the memory device 450 of the second entity's enrollment system 400. The candidate file database 606′ contains substantially the same or similar content as the candidate file database 606 located at the first entity.

As represented by block 608, an offer alert is sent to the qualifying customers notifying the customers that a special offer is available for them. Only targeted qualifying customers will receive offer alert(s) with the offer information. In general, the offer alert is communicated by the first entity (e.g., by the online system 300), but in some embodiments the offer alert could be communicated by the second entity (e.g., by the enrollment system 400) or some other entity on behalf of the first entity. There are several ways for targeted qualifying customers to get to the offer. For example, the customer may: (1) receive a targeted marketing e-mail indicating that the customer has been preselected to receive the special offer; (2) view the targeted offer in a special offer section of the website of the first entity's online system 300 (e.g., an online banking system) when the customer is logged into the customer's online account; (3) receive the targeted offer in a pop-up window or message after just having logged into or out of the first entity's online system 300; and/or (4) receive the offer via any other mechanism for communicating with the client. Some of these examples will be discussed in greater detail below.

Referring now to FIG. 6B, as represented by block 609, a determination is made as to whether the customer has received a targeted e-mail from a marketing department of the first entity, the targeted email including a targeted offer. If so, the customer is presented a link in the e-mail, as described in block 617. When the customer clicks or selects this link (block 618) using the personal computing device 200, the customer is directed to a network page hosted by the first entity's online system 300 (block 623). Then, as represented in block 624, the customer uses the personal computing device 200 to provide logon credentials to the online system 300 thereby authenticating the customer's identity when logging into the first entity's online system 300. When logged in, the special offer mentioned in the targeted email is eventually presented to the customer.

In some embodiments of the invention, instead of or in addition to presenting the special offer via a targeted email, the first entity may provide the special offer to a qualifying customer when the customer logs into or out of the online system 300. For example, as represented by block 610, if the customer has just logged out of the online system 300, the online system 300 detects the customer logout, as represented by block 620. In response to detecting the customer's logout, the online system 300 present a link to or other information about the special offer on the logout page, as shown in block 622, that indicates to the customer that a special offer is pending for the customer and accessible to the customer when the customer logs back into the online system 300. In the special offer, a link is provided that, when the customer selects the link (block 618), directs the customer back to the online system 300 to log back into the system (block 623). Then, as represented in block 624, when the customer logs back into the online system 300 by providing logon credentials to the online system 300, the special offer is immediately presented to the customer.

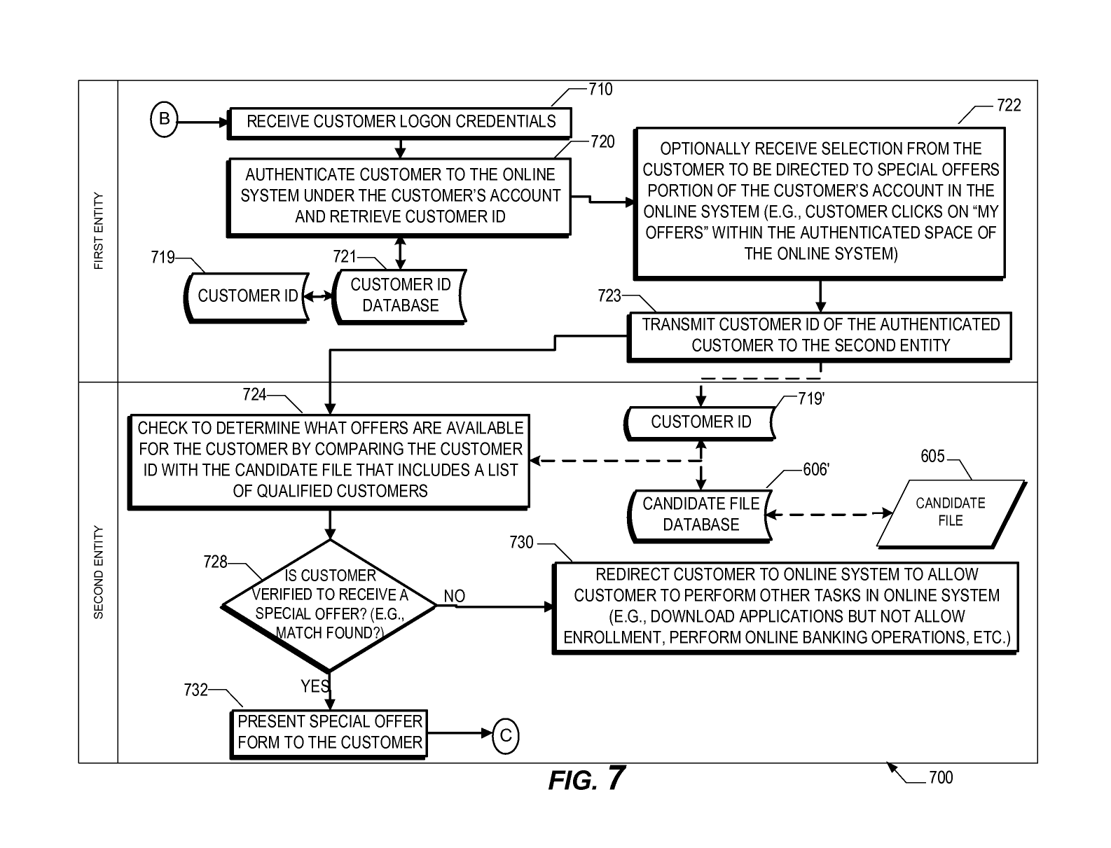

The special offer may additionally or alternatively be presented to the customer when the customer logs into the online system 300. For example, as represented by block 615, if the customer desires to log into the online system 300 for any reason, the customer then provides logon credentials into the online system (block 624) and a special offer may then be presented to the customer, as is discussed below with regard to FIG. 7. To log into the online system 300, the customer uses the personal computing device 200 to provide authentication information or logon credentials to the online system 300, such as username, password, security question answers, tokens, biometric information, and/or the like.

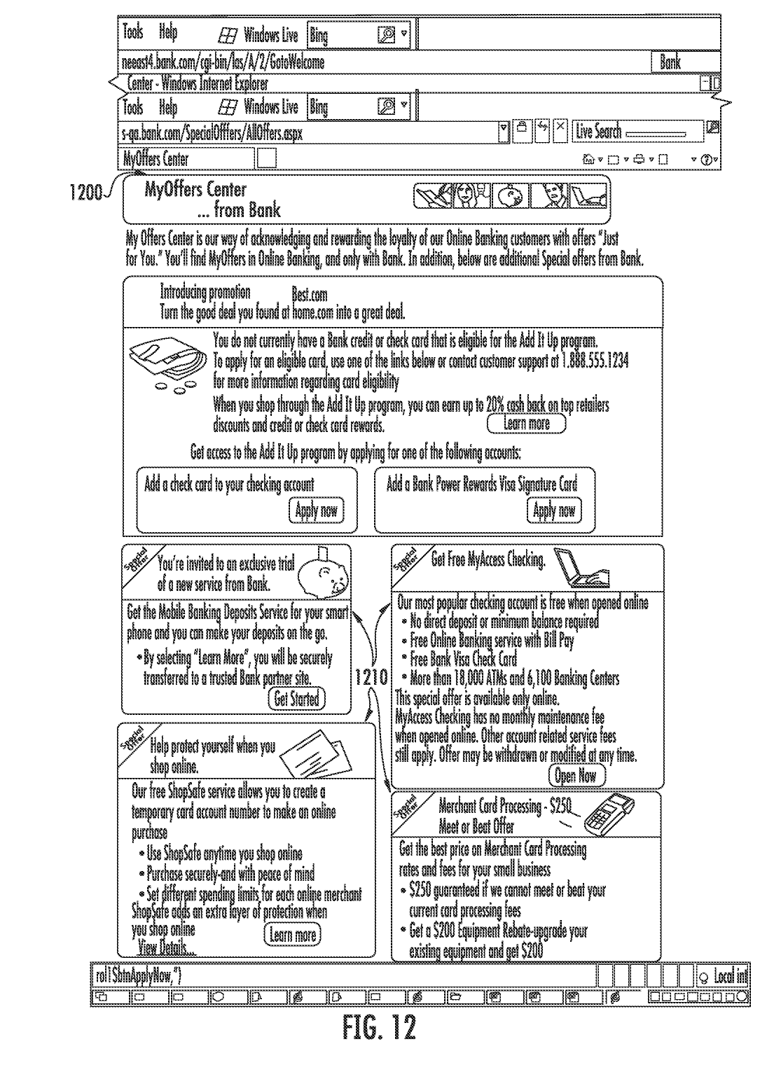

Referring now to FIG. 7, regardless of how the offer was presented to the customer, the customer is eventually directed to the online system 300 where the customer's logon credentials are received by the online system 300 of the first entity in block 710. The online system 300 of the first entity then determines whether or not the customer is authenticated to the online system based on the received logon credentials. If the logon credentials are authenticated by the first entity, the customer is authenticated to the online system 300 under the customer's account, as represented by block 720. In some embodiments, such as where the customer selected a link for the special offer in a targeted email, the customer may then be immediately forwarded to the enrollment system 400 of the second entity as described below. However, in other embodiments represented by block 722 such as where the customer is logging into the online system 300 in the normal course of business, the customer may be first directed to a home page hosted by the online system and the customer may then need to select a link that directs to a “special offers” portion of the website hosted by the online system 300 in order to view and express interest in the special offer. This will be discussed in more depth later with regard to FIG. 12.

After the customer has been authenticated to the online system 300 through the customer providing proper logon credentials for an account, and after the customer expresses interest in the special offer, the online system 300 communicates with the customer ID database 721 to retrieve the customer ID 719 of the authenticated customer. The retrieved customer ID 719 may be the customer name, customer account number, customer identification code, customer username, or any other identification that is associated with the authenticated customer, as previously mentioned.

As represented by block 723, after the customer expresses interest in a special offer, the online system 300 of the first entity forwards the customer to the enrollment system 400 of the second entity along with the customer ID of the authenticated customer. The second entity then stores the customer ID 719′ in the memory of the enrollment system 400. The enrollment system 400 of the second entity then uses the customer ID and the stored offer-specific candidate files 605 in the candidate file database 606′ to determine whether the customer is qualified to receive the particular special offer in which the customer expressed interest.

More specifically, as represented by block 724, a verification process occurs to determine whether the customer is qualified for the particular offer based on the customer ID 719′. For example, after the second entity receives the customer ID 719′, the second entity verifies whether the customer, via the customer ID 719′, qualifies for the offer. This happens by the enrollment system 400 comparing the received customer ID 719′ with the candidate file 605 stored in its memory to determine if the customer ID 719′ matches a customer ID listed in the candidate file 605. This process communicates with the candidate file database 606′ resident within on the memory of the enrollment system 400. The candidate file database 606′ was previously discussed with regard to FIGS. 3 and 6A. The candidate file database 606′ includes one or more candidate files 605 (one candidate file for each special offer) which includes a list of all customers that qualify for the special offer provided to the second entity by the first entity. As previously stated, the customer ID 719′ is stored at the second entity and may include the customer name, customer-representative identification, customer account information, or the like.

As represented by block 728, a determination is made by the enrollment system 400 of the second entity as to whether the customer is qualified to receive the particular special offer. This can happen by comparing the customer ID of the authenticated customer with the list of customer IDs in the candidate file and if there a match between the authenticated customer and the list of customers in the candidate file, then the customer is deemed verified. This process can be performed using database software and comparing two files—one containing the customer ID and the other being the candidate file. This comparison can happen in an automated fashion. For example, in automatic response to receiving the customer ID of the authenticated customer, the enrollment system 400 of the second entity automatically (without human intervention or without any intervening steps) compares the customer ID with the list of customer IDs in the candidate file associated with the particular special offer.

If the customer is not verified by the enrollment system 400 of the second entity (i.e., the customer ID is not on the candidate file's list of qualified customer IDs), the process 700 continues to block 730, where the customer is redirected back to the online system 300 and allowed to perform other tasks in the online system 300, such as online banking tasks. The customer may also be presented with information stating that the customer is not eligible for the particular offer at this time. For example, where the special offer is for a mobile deposits program provided by a bank, where a first customer receives the offer via an email and then forwards the email to a second customer (the second customer not having received an email from the bank because the second customer does not currently qualify for the mobile deposits program), the enrollment system 400 would not allow the second customer to enroll in the mobile deposits program or download the mobile deposits application because the second customer is not qualified and therefore would not have his or her customer ID in the candidate file associated with the bank's mobile deposits program.

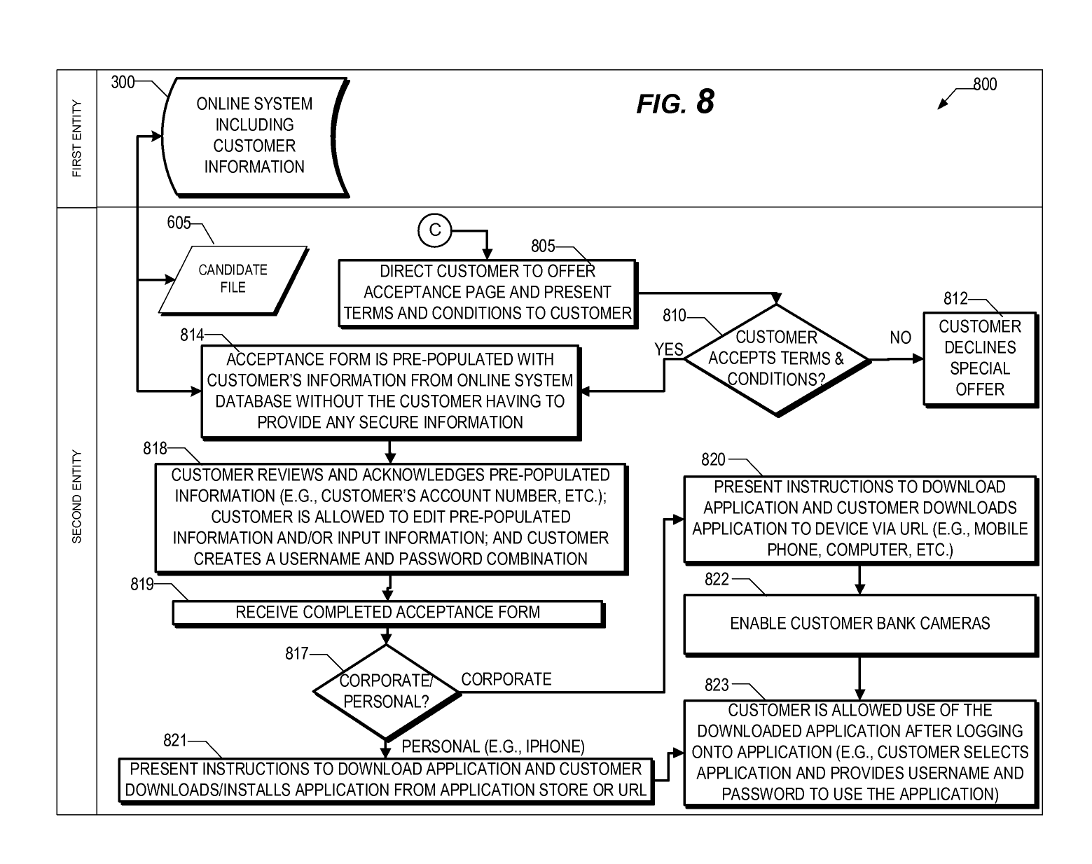

If, as represented by block 728, the customer is verified as being eligible for the special offer, the enrollment system 400 begins the enrollment process described with in FIG. 8 (or initiates whatever other offer-related service is provided by the second entity). As described above, in some embodiments of the invention, the special offer is presented to a customer by the first entity. However, it will be appreciated that other embodiments of the invention may be configured to have the special offer presented to the customer by the second after the verification process, as represented by block 732.

Referring now to FIG. 8, once the enrollment system 400 determines that the customer qualifies for the special offer, the enrollment system 400 then directs the customer to an offer acceptance/enrollment page and presents the terms and conditions of the special offer to the customer, as represented in block 805. As represented by block 810, a determination is made as to whether the customer accepts (block 814) or declines the special offer (block 812).

As represented by block 814, an acceptance form (i.e., enrollment form) is presented to the customer and, in some embodiments of the invention, is pre-populated with the customer's information that is received from the first entity's online system 300. As illustrated in process 800, the acceptance form is presented by enrollment system 400 of the second entity and is pre-populated with information obtained from either the candidate file 605 at the second entity or the online system 300 of the first entity. Nonetheless, the pre-populated information can be any information contained within the online system database 816 or candidate file 605, such as the last four digits of the customer's name, address, telephone number, the customer's personal preferences, customer's cell phone type, and/or any other information associated with the customer.

As represented by block 818, the customer reviews and acknowledges the pre-populated information that is filled in the acceptance form to verify accuracy thereof. In one embodiment, the customer is not allowed to modify at least some of the pre-populated fields (e.g., the customer's name) to prevent the customer from enrolling a different customer that is not qualified for the offer. In another embodiment, the customer is allowed to edit pre-populated information should the customer locate an error in the acceptance form or if the customer simply wishes to change the information to be submitted with the acceptance form. The customer is also allowed to input other information in the acceptance form that may not be pre-populated. The acceptance form may also solicit the customer to create a username and password combination that the customer will then use after enrollment to activate and use the application associated with the special offer.

After the customer completes the acceptance form, the customer submits the acceptance form, as represented in block 819. After the acceptance form is received by the first or second entity, instructions are presented to the customer to download the application associated with the special offer from the application download server 500, as shown in blocks 820 and 821.

In one embodiment, prior to download of the application, the customer selects what type of personal computing device (e.g., corporate, personal, etc.) that the customer will use to run the downloaded application, as represented in block 817. If the device is for personal use, the process 800 continues to block 821, where instructions are presented to download the application from the application download server 500.

If the device is for corporate use, the process 800 continues to block 820, where the application may be downloaded from any website or URL and is installed directly onto the computing device (e.g., smartphone, laptop, etc.) of the customer. Additionally, if the device use is corporate, the customer bank cameras may be enabled, as illustrated in block 822.

Other operations may occur based on whether the downloading device will be a Blackberry® device or an iPhone® device. iPhone® is a trademark of Apple, Inc. in the United States, other countries or both. Blackberry® is a trademark of Research in Motion Limited Corporation in the United States, other countries or both.

In block 823, the customer is allowed use of the downloaded application after the customer provides a username and password to the application. Particularly, the customer selects the downloaded application on the personal computing device and once the customer then provides the username and password to application, the application and all features thereof are then accessible and usable by the customer. For example, if the application is a mobile deposits application, the customer can begin making check deposits from the customers mobile phone. In some embodiments, the mobile deposits application is an application where the customer can take a picture of a check that the customer wishes deposit into the customers account at a financial institution. The customer takes a picture of both the front portion of the check and the executed back portion of the check and uploads these check images to the financial institution, which, in turn, can deposit appropriate funds into the customer's account based on the deposited check. Such application may be owned and managed by a third-party and offering and enrolling certain pre-qualified customers in such application is described above.

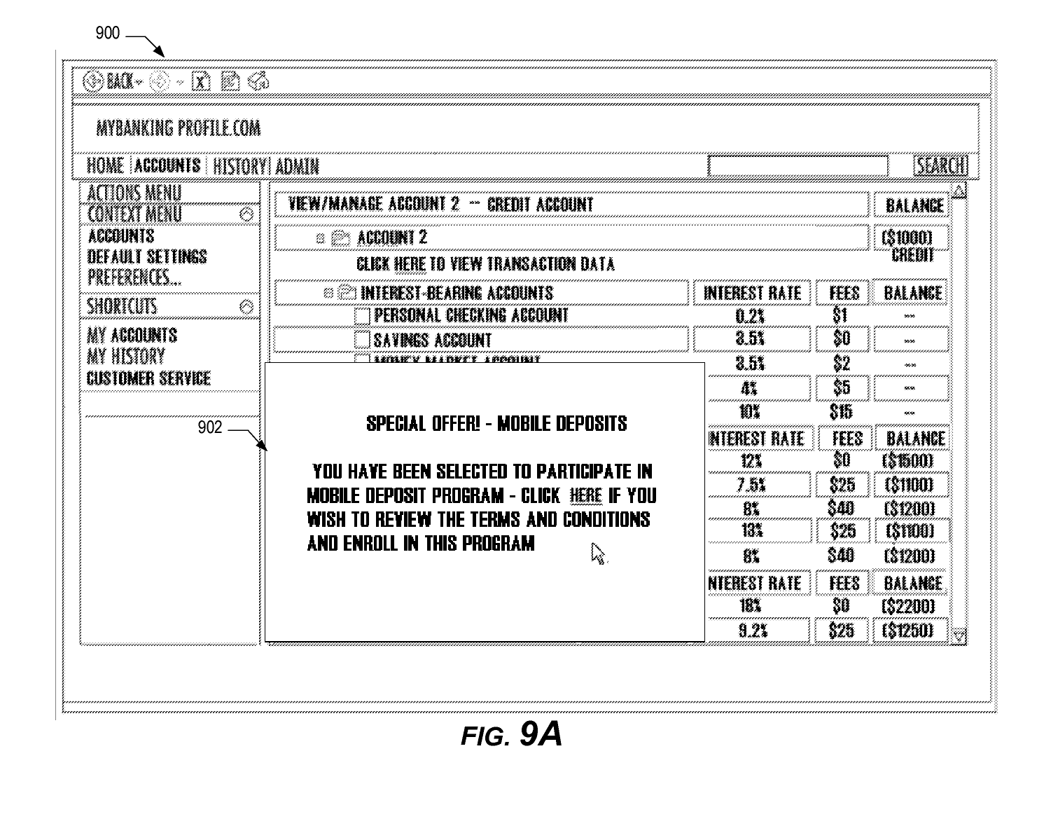

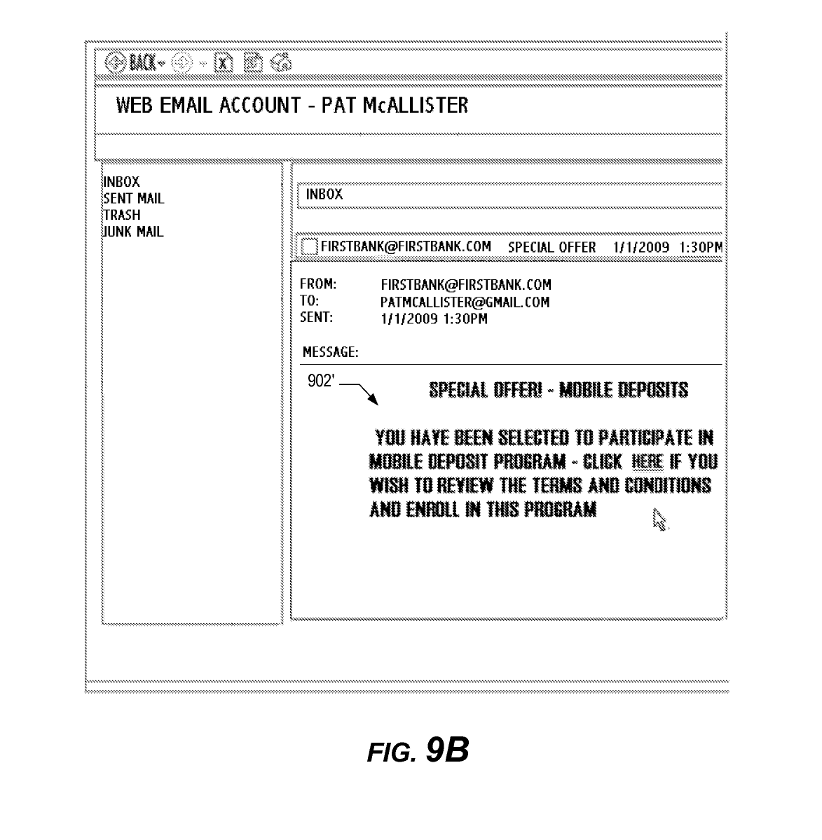

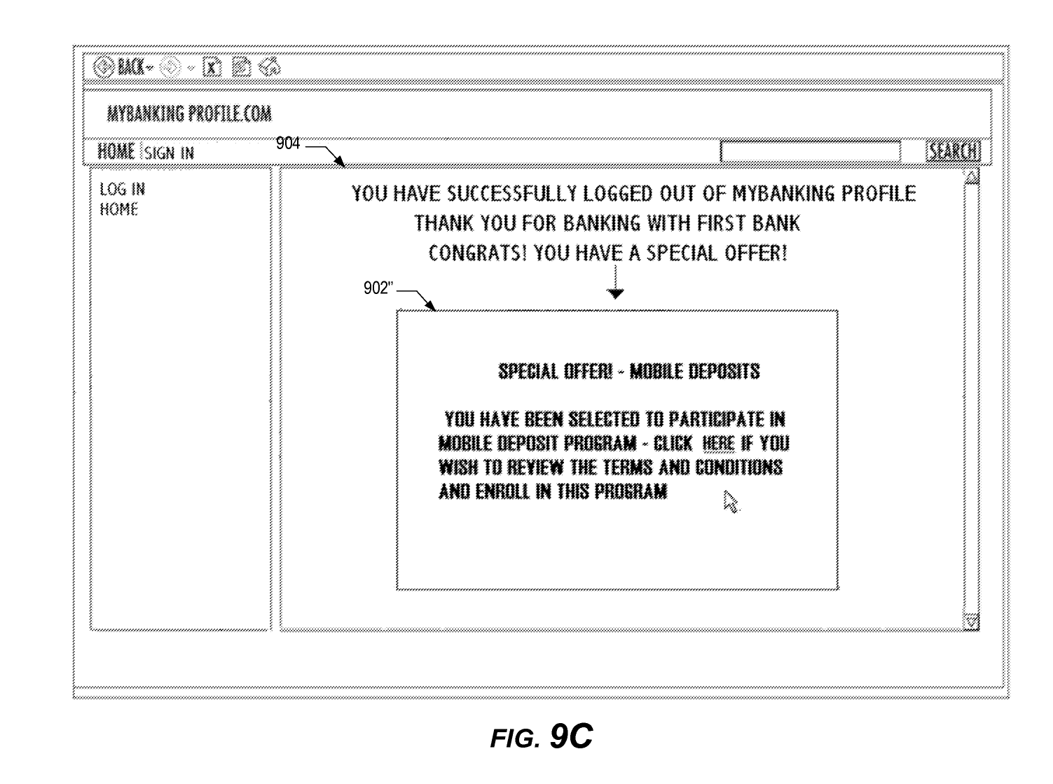

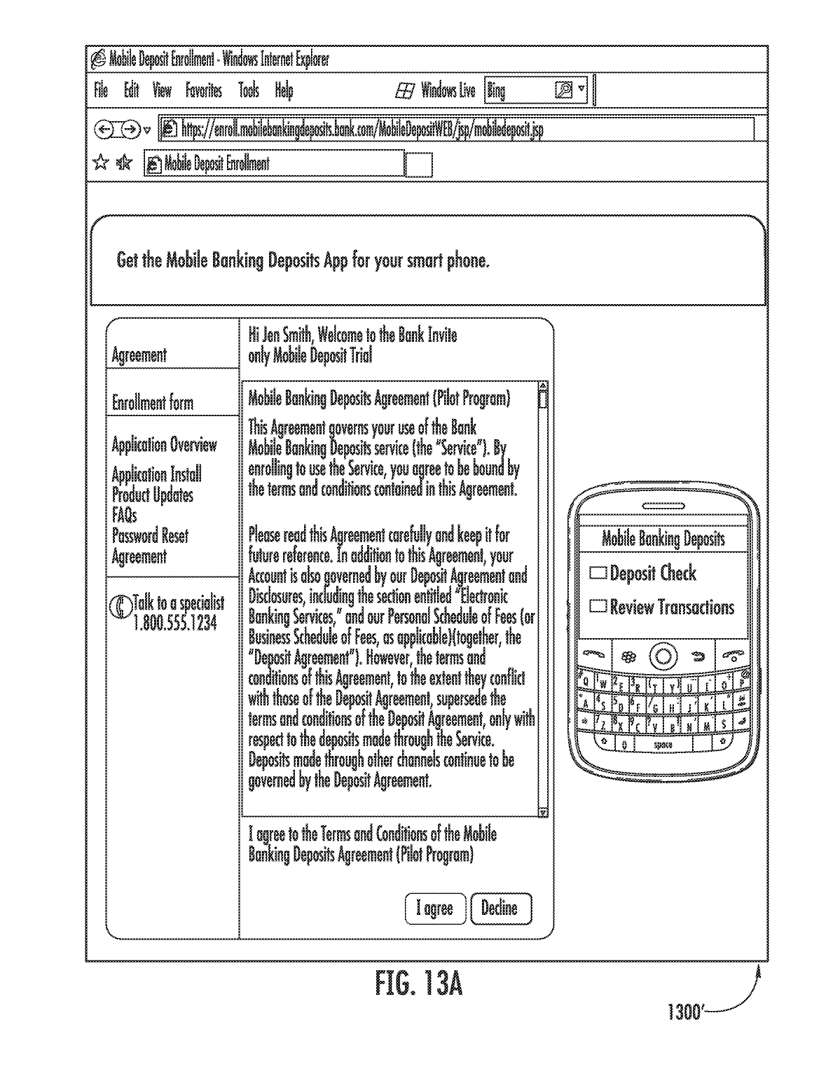

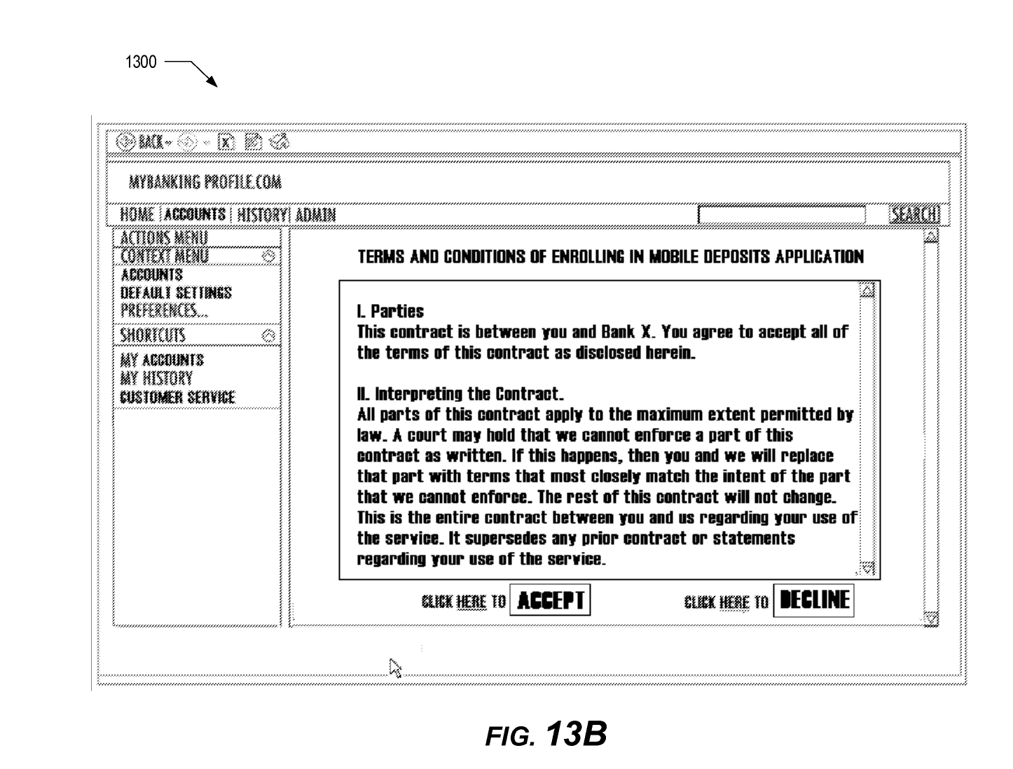

FIGS. 9-20 provide graphical user interfaces configured to be displayed on the customer's personal computing device 200 to illustrate an exemplary process to offer and enroll a customer in a product, in accordance with an exemplary embodiment of the invention. Specifically, these exemplary user interfaces illustrate an example embodiment of the invention that offers a mobile deposits application to select customers of a financial institution. In one embodiment, the user interfaces displayed in FIGS. 9A and 9C-12 are presented to the customer's personal computing device 200 by the online system 300, while the user interfaces displayed in FIGS. 13A-20 are presented to the customer's personal computing device 200 by the enrollment system 400.

In FIGS. 9A-9C, an offer alert is being presented to the customer, as previously discussed with regard to block 608 of FIG. 6A. In FIG. 9A, a customer is shown as being logged into an online banking system 900 provide by, for example, the online system 300 of FIG. 1. As shown, the online banking system allows the customer to perform various operations for the customer's account associated with the financial institution. While the customer is logged on to the online banking system, a pop-up window 902 presents a special offer to the customer. The special offer illustrated in FIG. 9A is a mobile deposits application offer that is presented immediately in response to the customer logging into the customer's online banking account. In the pop-up window 902, the customer is presented with an option to review the terms and conditions and enroll in the presented program by clicking a link in the pop-up window 902.

In FIG. 9B, the customer is checking her email and the customer receives an email alert indicating a special offer is available for the customer. In the email message body 902′, the customer is presented with an option to review the terms and conditions and enroll in the presented program by clicking a link in the message body 902′. The link directs the customer to first log into the online system 300 of the first entity.

FIG. 9C illustrates the result of a customer logging out of the online system 300 of the first entity. The illustrated page 904 of FIG. 9C is the logout page 904 of the online system 300 presented directly in response to the customer logging out of the online system 300. The logout page 904 presents a message 902″ including an option to review the terms and conditions and enroll in the presented program by clicking a link in the message 902″. The link directs the customer to first log into the online system 300 of the first entity.

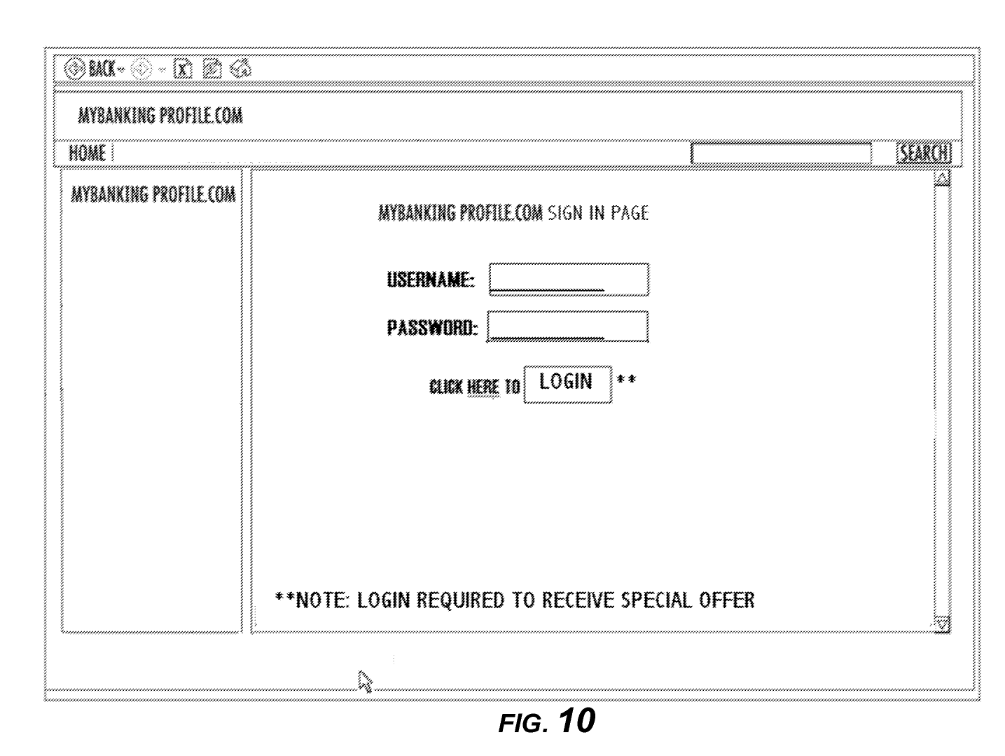

The methods shown in FIGS. 9A-C are just examples of how an offer alert can be presented to the customer. Other methods may also be employed that will present the customer with a message and optionally include a link to access the offer by logging into the online system of the first entity. When the customer clicks on the link or goes to login to the online system 300 of the first entity, the customer is then allowed to present the customer's login credentials, as illustrated in the GUI of FIG. 10. Optionally a note can be added to the GUI indicating that the customer must login to receive the special offer.

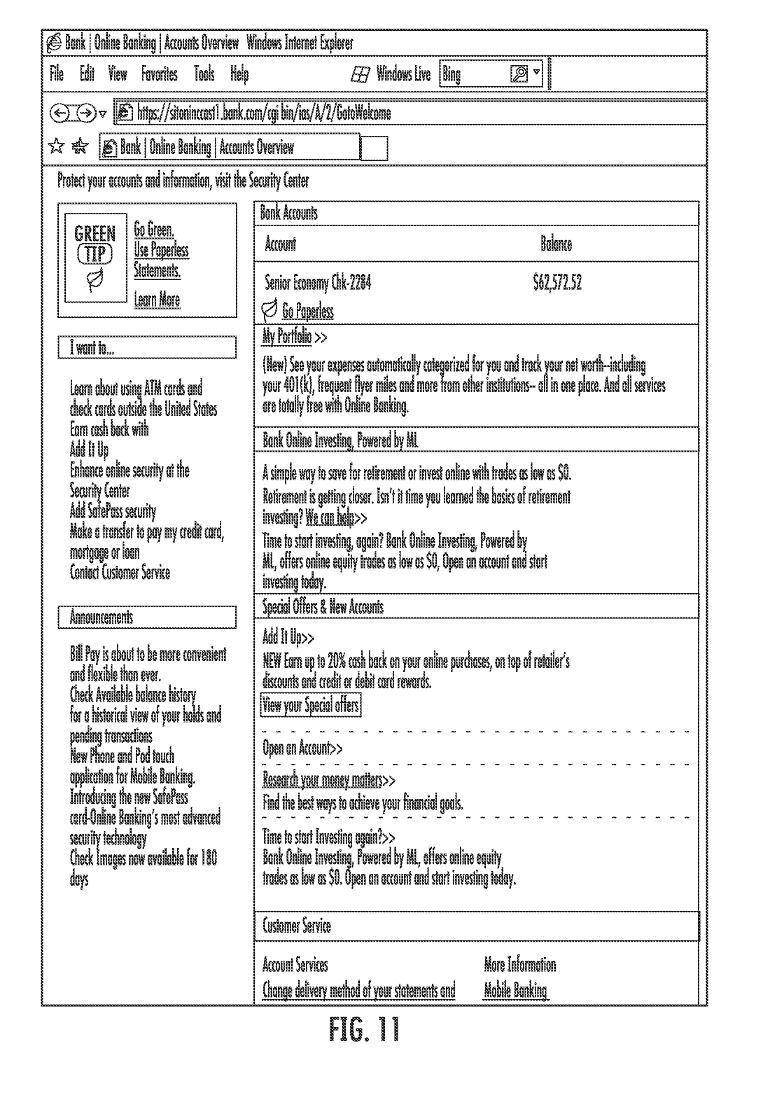

In some embodiments of the invention, the special offer may be resident on a special section of the online system 300 of the first entity (or at the enrollment system 400 of the second entity), such as a “Special Offers” portion or “My Offers” portion associated with the customer's account. To be directed to such section, the customer selects a link that directs the customer to the offer portion of the customer's account where any or all of the offers that the customer qualifies for are presented to the customer. The customer clicks on “My Offers” within the authenticated space of the online system to be directed to all offers for which the customer qualifies. Examples of such a process are illustrated later with respect to FIGS. 11 and 12.

After the customer provides login credentials, the homepage of the online system 300 of the first entity is displayed, as exemplified by FIG. 11. The special offer may be resident on a special section of the website, such as a “Special Offers” portion or “My Offers” portion associated with the customer's account. As shown in on the homepage of FIG. 11, to be directed to such section, the customer selects a link or other re-direction method to be directed to the offer portion of the customer's account where any or all of the offers that the customer qualifies for are presented to the customer. The customer clicks on “View your Special Offers” within the authenticated space of the online system 300 to be directed to all offers for which the customer qualifies. The homepage of FIG. 11 illustrates that the user may perform other typical online banking operations and the special offer is presented within such interface.

An example of the “Special Offers” page 1200 is illustrated in FIG. 12, which is labeled in FIG. 12 as “MyOffers Center.” As illustrated, the MyOffers Center of the website hosted by the online system 300 shows, in this example, four special offers 1210. Each of these special offers 1210 includes a brief description of the offer and a link that will direct the customer to the second entity's site for verification and enrollment. At this point, the first entity has typically already supplied a candidate file to the second entity, which in turn has stored the candidate file in memory or database(s). When the customer clicks on one of the special offers 1210 the customer ID is then sent to the second entity. The second entity receives the customer ID in response to the customer logging into the online system 300 of the first entity and expressing interest in the offer such that the verification process can occur when the customer logs into the online system, when the customer clicks on the link for the special offer 1210, or anytime therebetween. As previously discussed, when the customer ID (e.g., customer identifying code, etc.) is received by the second entity, the second entity can then compare the customer ID (supplied by the first entity after the customer is authenticated to the online system at the first entity) with the candidate file or other list of qualified customers supplied by the first entity to verify the particular customer qualifies for the selected special offer.

When the customer clicks on the special offer and is verified, the customer is presented a terms and conditions interface for the customer to review and accept, as illustrated in the exemplary embodiments of FIGS. 13A-B. The customer must accept the terms and conditions prior to enrolling in the mobile deposits application or other offered product. To accept the terms and conditions, the customer may click the “I Agree” or “ACCEPT” button provided in the interface 1300, 1300′. Alternatively, the customer may click the “DECLINE” button and the interface 1300, 1300′ to decline the offer.

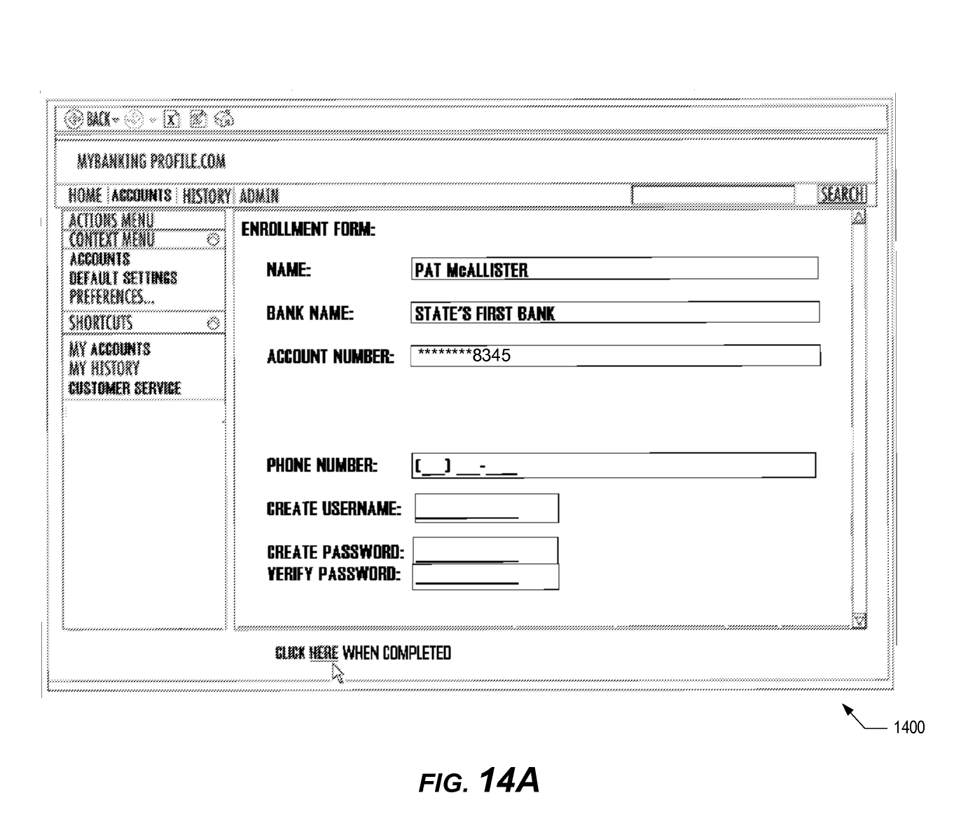

In FIGS. 14A-14B, an offer form 1400, 1400′ is presented to the customer in response to the customer accepting the terms and conditions. The offer form 1400 of FIG. 14A includes name, bank name, account number, phone number, “Create Username,” “Create Password,” and “Verify Password” fields. The customer name, bank name, and account number are pre-populated fields that are pre-populated using the customer information contained in the candidate file and associated with the particular customer ID supplied to the second entity by the first entity. Other pre-populated fields are also possible. Similarly, in the offer form 1400′ of FIG. 14B, the user ID, account number, and account name are fields that are pre-populated by retrieving information from the candidate file and/or retrieving information directly from the first entity. The customer may change the pre-populated information and/or add additional information into fields that have not been filled in, such as the customer's phone number. The customer may also create a username and password as illustrated in the acceptance form 1400, 1400′.

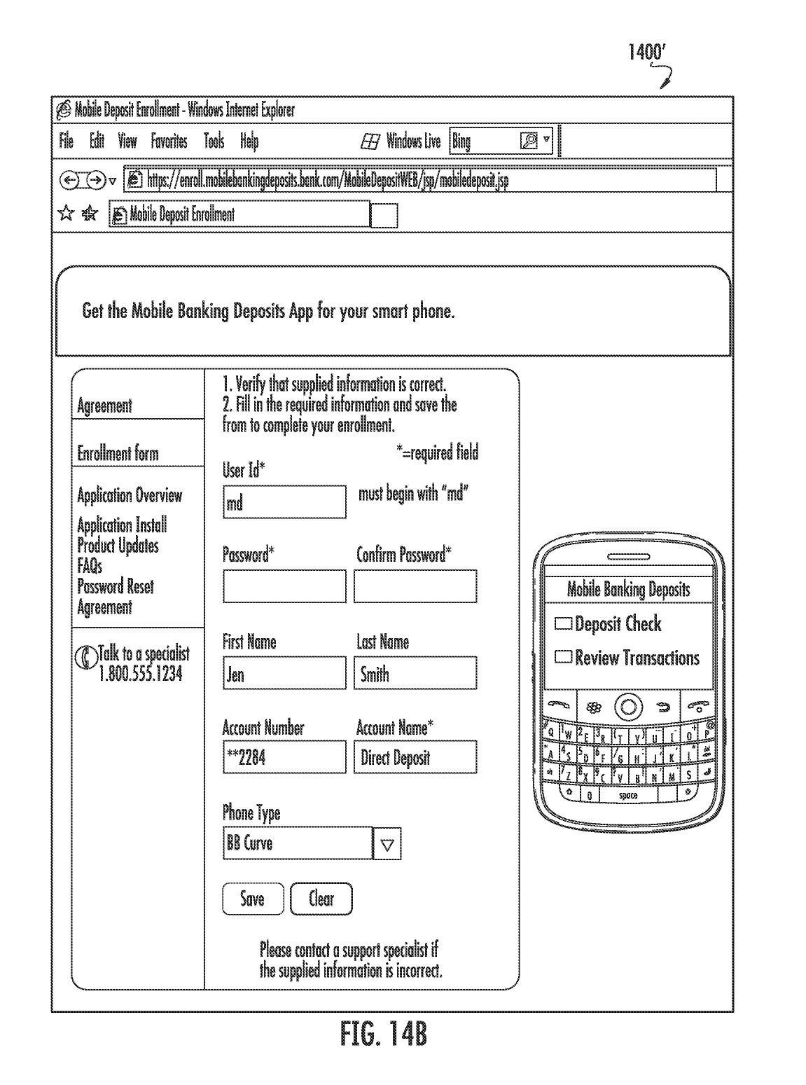

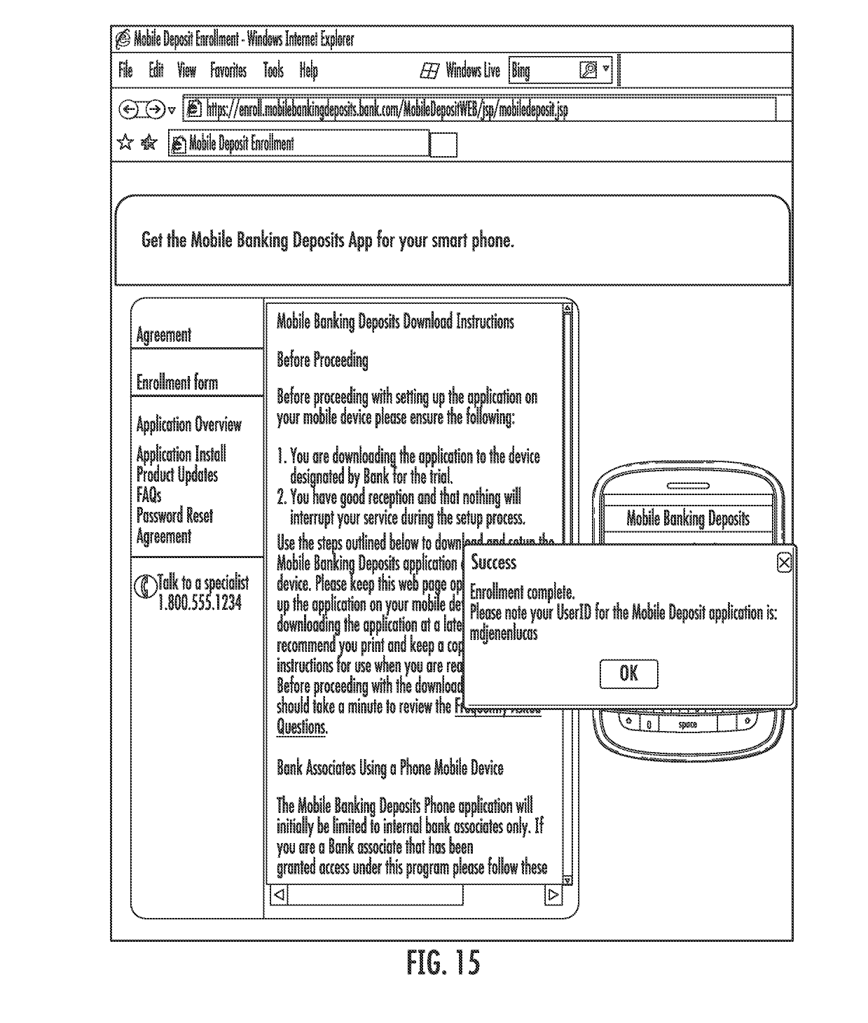

After the acceptance form 1400, 1400′ has been completed and submitted to the second entity (or the online banking system), the information is then saved in a database at the first and/or second entity and the customer is enrolled in the special offer. Additionally, the customer is notified of the enrollment via an “Enrollment Complete” screen (or other similar notification screen), as shown in FIG. 15.

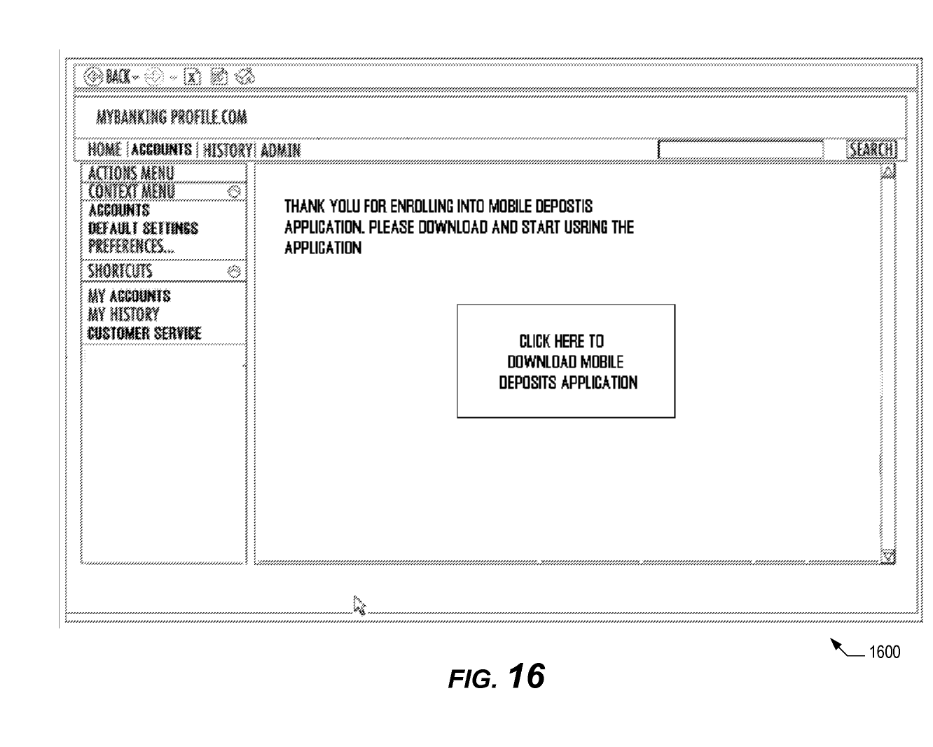

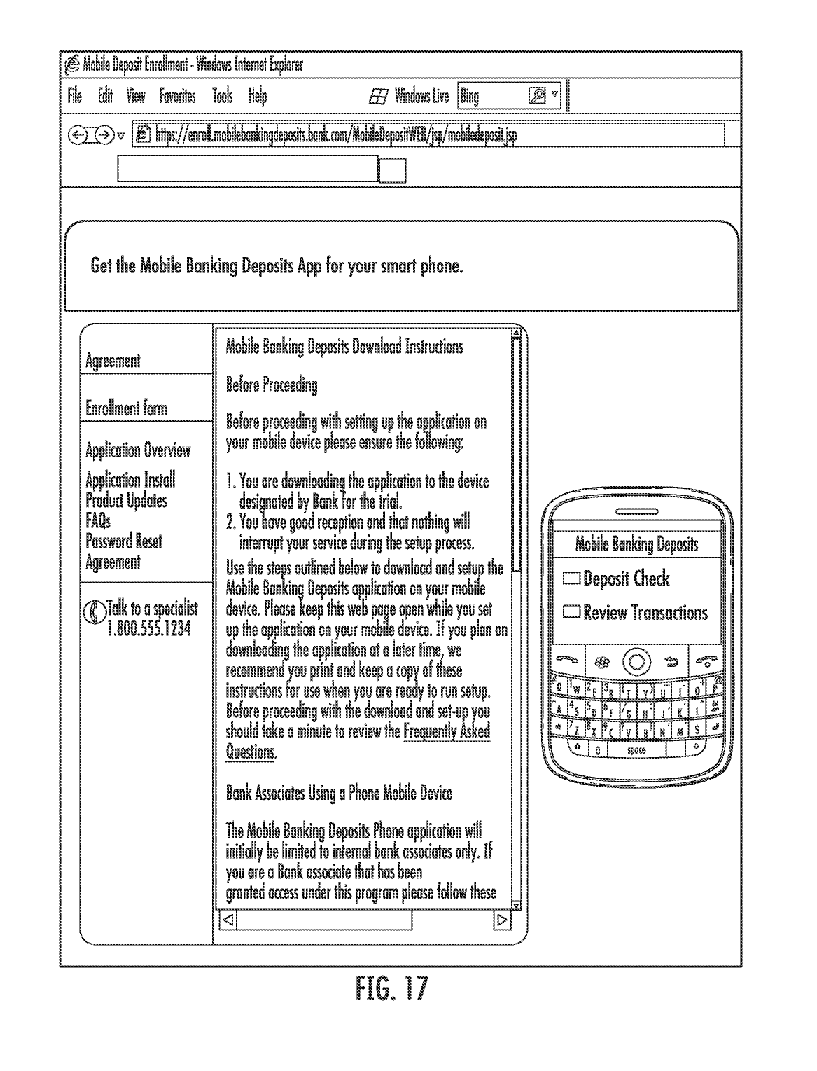

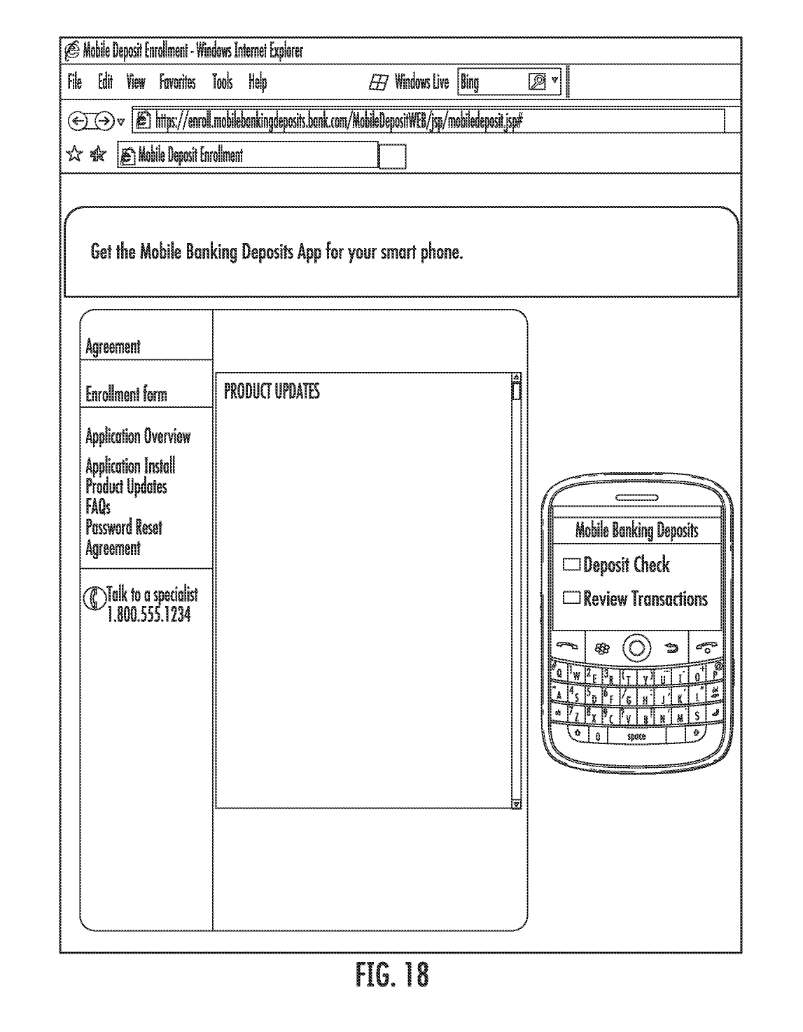

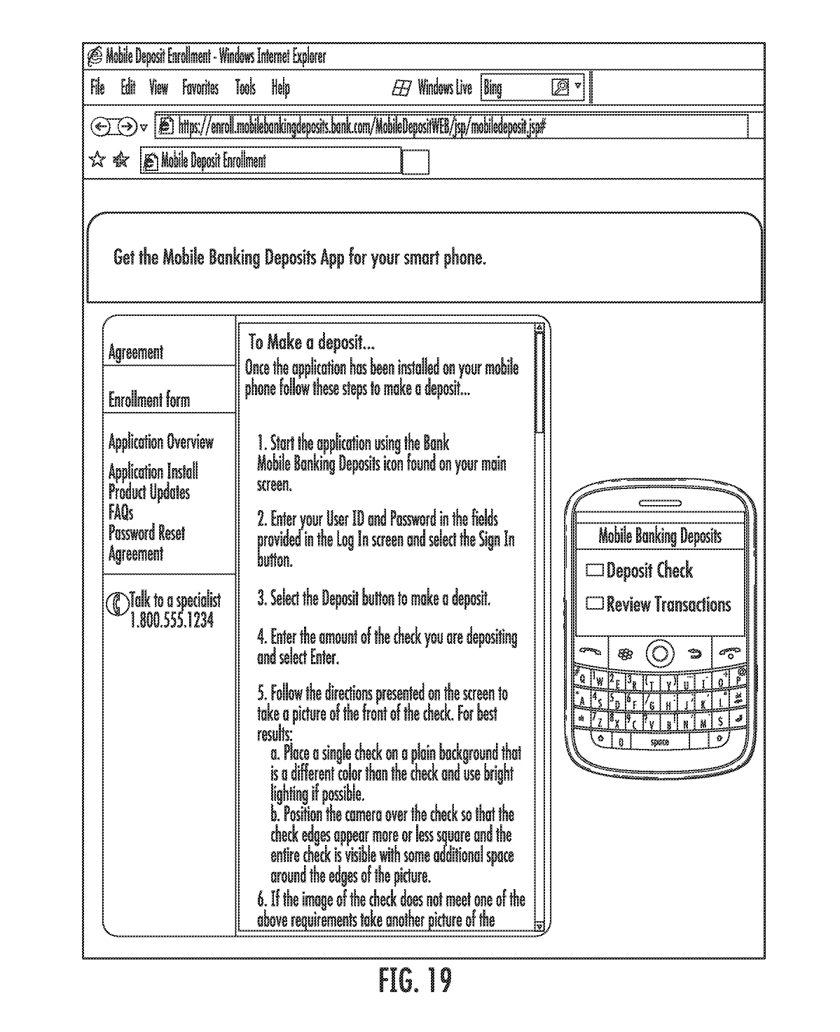

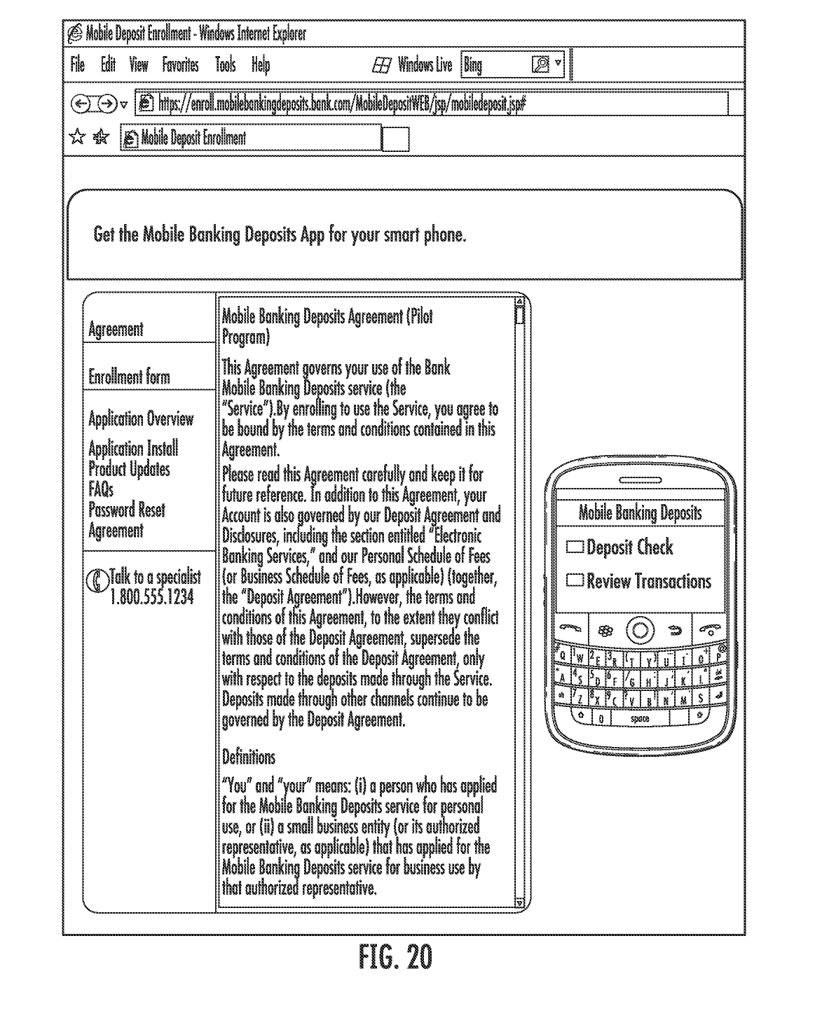

After notification of completed enrollment, the customer will be re-routed to a screen that allows the customer to realize the special offer. For example, as illustrated in FIG. 16, the customer may be directed to a page 1600 to download a mobile deposits application onto the customer's personal computing device. Downloading instructions would be presented to the customer, as illustrated in FIG. 17 and in FIG. 18 a product overview is presented to the customer. Instructions and details about the program that the customer just enrolled in are presented to the user in FIGS. 19 and 20. For example, the customer is presented with details on how to operate the downloaded program in FIGS. 19 and 20 and the user agreement is viewable by the user.

As will be appreciated by one of skill in the art, the present invention, as described hereinabove and in FIGS. 1-20, may be embodied as a method (e.g., a computer-implemented process, a business process, or any other process), apparatus (including a device, machine, system, computer program product, and/or any other apparatus), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

When executed by a processor, the computer-executable code may be operable to perform a certain function by instructing the processor to perform the function. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

Any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

Computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of apparatuses and/or methods. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory and/or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

It will be appreciated that a processing device, processor, communication device, memory device, and any other device described herein may each comprise a single such device or a plurality of such devices working together to perform the functions of the device described herein. In other words, for example, as used in herein and in the claims, the phrase “a processing device” may refer to a plurality of processing devices each performing some portion of the functions of the recited processing device.

While certain exemplary embodiments have been described and shown in the accompanying drawings, it is to be understood that such embodiments are merely illustrative of and are not restrictive on the broad invention, and that the embodiments of invention are not limited to the specific constructions and arrangements shown and described, since various other changes, combinations, omissions, modifications and substitutions, in addition to those set forth in the above paragraphs, are possible. Those skilled in the art will appreciate that various adaptations, modifications, and/or combination of the just described embodiments can be configured without departing from the scope and spirit of the invention. Therefore, it is to be understood that, within the scope of the appended claims, the invention may be practiced other than as specifically described herein. For example, unless expressly stated otherwise, the steps of processes described herein may be performed in orders different from those described herein and one or more steps may be combined, split, or performed simultaneously. Those skilled in the art will also appreciate, in view of this disclosure, that different embodiments of the invention described herein may be combined to form other embodiments of the invention.

What is claimed is:

1. A method comprising:
sending a candidate file from a computer system of a first entity to a second entity, the candidate file comprising a list of customer identifiers associated with customers of the first entity that qualify for an offer;
authenticating a customer using a computer system of the first entity; and
transmitting a customer identifier from a computer system of the first entity to the second entity based at least partially on the authenticating the customer,
wherein, in response to the customer identifier being transmitted to the second entity, the second entity:
verifies that the customer qualifies for the offer using the candidate file and the customer identifier, and
provides a service related to the offer in response to the customer being verified to receive the offer.

2. The method of claim 1, wherein the service comprises an enrollment service, and wherein the method further comprises:
storing information in a memory of a computer system of the first entity related to the enrollment of the customer in a product associated with the offer.

3. The method of claim 1, further comprising:
pre-populating an offer form with the customer information associated with the customer identifier.

4. The method of claim 1, further comprising:
transmitting an offer alert to the customer indicating that the customer qualifies for the offer, the offer alert comprising a link which will redirect the customer to the computer system of the first entity that performs the authenticating.

5. The method of claim 1, wherein the second entity is separate from the first entity.

6. The method of claim 1, further comprising:
directing the customer to a computer system of the second entity through which the second entity provides the service.

7. The method of claim 1, wherein the first entity comprises a financial institution, and wherein the authenticating comprises authenticating the customer into an online banking system.

8. The method of claim 7, wherein the offer is for a mobile deposits program, and wherein the service comprises an enrollment service or a mobile deposits application download service.

9. The method of claim 1, wherein the list of customer identifiers in the candidate file includes customer identifiers for some but not all of the first entity's customers.

10. The method of claim 1, wherein the customer identifiers do not include confidential information about the customer.

11. The method of claim 1, wherein the customer identifiers do not, themselves, include information that reveals the identity of customers or customer accounts associated with the customer identifiers to any entity other than the first entity.

12. An apparatus comprising:
a memory device comprising stored therein authentication information and customer identifiers for each of a plurality of customers of a first entity; and
a processing device operatively coupled to the memory device and configured to:
send a candidate file to a second entity, the candidate file comprising a list of customer identifiers associated with customers of the first entity that qualify for a special offer;
authenticate a customer using the authentication information; and
transmit a customer identifier to the second entity in response to the customer being authenticated,
wherein, in response to the customer identifier being transmitted to the second entity, the second entity:
verifies that the customer qualifies for the special offer using the candidate file and the customer identifier, and
provides a service related to the special offer in response to the customer being verified to receive the special offer.

13. The apparatus of claim 12, wherein the service comprises an enrollment service, and wherein the processing device is further configured to :
receive information related to enrollment of the customer in a product associated with the special offer; and
store the information related to enrollment in the memory device.

14. The apparatus of claim 12, wherein the processing device is further configured to:
transmit an offer alert to the customer indicating that the customer qualifies for the special offer, the offer alert comprising a link directing the customer to a request for authentication information or to a server of the second entity.

15. The apparatus of claim 12, wherein the processing device is configured to:
direct the customer to a computer system of the second entity through which the second entity provides the service.

16. The apparatus of claim 12, wherein the first entity comprises a financial institution, and processing device is configured to authenticate the customer into an online banking system.

17. The apparatus of claim 16, wherein the special offer is for a mobile deposits program, and wherein the service comprises an enrollment service or a mobile deposits application download service.

18. The apparatus of claim 12, wherein the list of customer identifiers in the candidate file includes customer identifiers for some but not all of the first entity's customers.

19. The apparatus of claim 12, wherein the customer identifiers do not, themselves, include information that reveals the identity of customers or customer accounts associated with the customer identifiers to any entity other than the first entity.

20. A computer program product comprising a non-transitory computer readable medium, wherein the non-transitory computer readable medium comprises computer-executable program code configured to cause a computer to perform a method, the method comprising:
sending a candidate file from a computer system of a first entity to a second entity, the candidate file comprising a list of customer identifiers associated with customers of the first entity that qualify for an offer;
authenticating a customer using a computer system of the first entity; and
transmitting a customer identifier from a computer system of the first entity to the second entity based at least partially on the authenticating the customer,
wherein, in response to the customer identifier being transmitted to the second entity, the second entity:
verifies that the customer qualifies for the offer using the candidate file and the customer identifier, and
provides a service related to the offer in response to the customer being verified to receive the offer.

21. A method comprising:
receiving, using a computer system at a second entity, a candidate file from a first entity, the candidate file comprising a list of customers of the first entity that qualify for an offer;
receiving, at the computer system, a customer identifier identifying the customer in response to the customer being authenticated by a computer system of the first entity;
verifying that the customer qualifies for an offer based on the candidate file and the customer identifier in response to the customer identifier being transmitted to the second entity; and
performing a service related to the offer in response to the verifying that the customer qualifies for the offer.

22. The method of claim 21, wherein the service comprises an enrollment service for enrolling the customer in the product.

23. The method of claim 21, wherein the service comprises an application download service for allowing the customer to download an application related to the offer.

24. The method of claim 21, further comprising:
pre-populating an offer form with at least some customer information contained within the candidate file stored at the second entity.

25. The method of claim 21, wherein the list of customers comprises a list of customer identifiers, and wherein verifying that the customer qualifies for the offer comprises comparing the customer identifier with the list of customer identifiers.

26. The method of claim 21, wherein the second entity is separate from the first entity.

27. An apparatus comprising:
a memory device; and
a processing device operatively coupled to the memory device and configured to:
receive a candidate file from a first entity, the candidate file comprising a list of customers of the first entity that qualify for an offer;
store the candidate file in the memory device;
receive a customer identifier identifying the customer in response to the customer being authenticated by a computer system of the first entity;
verify that the customer qualifies for an offer based on the candidate file stored in the memory device and the customer identifier in response to the customer identifier being transmitted to the second entity; and
perform a service related to the offer in response to the verifying that the customer qualifies for the offer.

28. The apparatus of claim 27, wherein the service comprises an enrollment service for enrolling the customer in the product.

29. The apparatus of claim 27, wherein the service comprises an application download service for allowing the customer to download a software application related to the offer.

30. The apparatus of claim 27, wherein the processing device is further configured to pre-populate an offer form with at least some customer information.

31. The apparatus of claim 27, wherein the processing device permits the customer to edit some, but not all, of the pre-populated information in the offer form.

32. The apparatus of claim 27, wherein the list of customers comprises a list of customer identifiers, and the processing device is configured to verify that the customer qualifies for the offer by comparing the customer identifier with the list of customer identifiers.

33. The apparatus of claim 27, wherein the apparatus is maintained by a second entity, and wherein the second entity is separate from the first entity.

34. A computer program product comprising a non-transitory computer readable medium, wherein the non-transitory computer readable medium comprises computer-executable program code configured to cause a computer to perform a method, the method comprising:
receiving a candidate file from a first entity, the candidate file comprising a list of customers of the first entity that qualify for an offer;
receiving a customer identifier identifying the customer in response to the customer being authenticated by a computer system of the first entity;
verifying that the customer qualifies for an offer based on the candidate file and the customer identifier in response to the customer identifier being transmitted to the second entity; and
performing a service related to the offer in response to the verifying that the customer qualifies for the offer.
